(19) United States
(12) Patent Application Publication
(10) Pub. No.: US 2006/0113733 A1
(43) Pub. Date: Jun. 1, 2006

(54) Wheel construction and a vehicle provided with the wheel construction

(75) Inventor: Kazuyoshi Kazaoka, Shizuoka (JP)

Correspondence Address: Patrick G. Burns, Esq.;GREER, BURNS & CRAIN, LTD., Suite 2500, 300 South Wacker Dr., Chicago, IL, 60606, US

(73) Assignee: JCT CORPORATION

(21) Appl. No.: 11/121,984

(22) Filed: May 4, 2005

(30) Foreign Application Priority Data
Oct. 4, 2004 (JP) 2004-5837
Nov. 12, 2004 (JP) 2004-328411

(51) Int. Cl. B62B 5/02

(52) U.S. Cl. 280/5.24

(57) ABSTRACT

The present invention is to provide a wheel construction having a simple and an economical configuration as well as highly utilization value with compacted configuration and having a characteristics in which it can easily climb over an obstacles including a step portion or a projected portion each having a predetermined height with the simple configuration and with a simple operation so that it can climb over such obstacles by a manual operation of the user thereof, and a wheel construction of the present invention comprising a wheel supporting portion, a wheel axis, a vehicle body portion, a vehicle body connecting portion, a sliding member provided on a lower edge portion of the wheel supporting and a resilient member and wherein it further comprising a wear preventing member which can prevent an outer surface of the sliding member from being worn away and which being provided on at least a portion of an outer surface of the sliding member forming the curved contour and facing to the moving surface.

### FIELD OF THE INVENTION

The present invention relates to a wheel construction and a vehicle provided with the wheel construction and specifically the present invention relates to a wheel construction and a vehicle provided with the wheel construction which can easily climb over obstacles for a vehicle such as a step-like portion, a projecting portion or the like which are existing on a moving surface along which the vehicle moves

### DESCRIPTION OF THE RELATED ARTS

In the past, it is acknowledged that vehicles moved and run by man power as shown in FIG. 13, a push-car, a wheel chair, a baby car, a vehicle used for a silver-aged person, a vehicle for carrying kids thereon or the like, are suffered from some troubles which result in making a performance of the user thereof inconvenient when these vehicles meet with a step even having a height being around 3 cm or the like and which is caused by a threshold made by a building part in a building or a house as well as with a step caused by an edge stone on a pedestrian passage, a stone or a rock, a wooden brick or a timber, dusts or a projecting portion formed by a concave or a convex portion made by natural phenomenon, in out door.

Note that, in the past, the above-mentioned vehicles as shown in FIG. 13, is moved along a predetermined moving surface either in an indoor or in an outdoor, by a person who applies a pulling force or a drawing force to the vehicle.

On the other hand, as the wheel chair, the vehicle is moved along a predetermined moving surface either in an indoor or in an outdoor by man-power generated by a user who gets on this vehicle and who rotates wheels thereof by his hand.

However, it is also acknowledged that a significant working power is usually required for the user of the vehicle when the user makes the vehicle climbed over a just small projecting portion or a step to go forward or it was necessary to make a detour by finding a safety passage and thus there exists a drawback in spending a lots of unnecessary times and consuming a large amount of labor force.

This situations is apparently applicable to the vehicle as mentioned above and a vehicle moved by an electric or fuel-cell battery.

Note that, a resolving means for eliminating such a step portion against the vehicles in a building or a house in the past is, for example, to make use of a plate forming an inclination between the moving surface and the top of the obstacles so as to form a tiny slope therebetween.

On the other hand, in an out door, there are many number of such steps however it is also understood that under the present situation, it is quite difficult to set such inclination-forming-plate on the edge stone of the pedestrian passage.

Further, for the push-car, for example, it is also present situation in that a driver for delivering special couriers always carries with such inclination-forming-plate and uses it when it is necessary.

In order to resolve these problems in the past, for example, Japanese Unexamined Patent Publication (KOKAI) No. 10-297206, U.S. Pat. No. 3,239,872 or DE4040283 discloses an automatic swing type step covering device in that a castor which is provided on one end portion of a various kinds of vehicles in a moving direction thereof, is provided with a swing member at a side portion of the castor and which having a curved contour including a circular configuration having a diameter being larger than that of the wheel of the castor and wherein the swing member is swingably attached to the side portion of the castor and at a position higher than a rotational axis of the wheel of the castor.

The swing type step covering device as used for a front wheel of the vehicle in the past, is configured so that when the vehicle met a step on the moving surface of the vehicle in the moving direction, a predetermined curved portion comprising a front lower end portion of the swing member is first abutted with the step then because the swing member is rotated at the abutting point formed between the swing member and the step portion as a center portion due to a continuous forward movement of the vehicle, a swinging center point of the swing member is raised by the rotation of the swing member around the abutting point as a rotational center, thereby the rotational axis of the wheel of the castor is also raised.

Then, after the wheel of the castor has landed on an upper surface of the step, the swing member is released from the abutting point and therefore, it is returned to an original position by a spring force or the like.

However, the step covering device having the above-mentioned construction has problems in which since it has a complicated configuration in its mechanism as well as a height of the wheel construction per se, is necessarily become higher, the areas to which this kind of device can be applied is limited and simultaneously with this, a cost for making this device is increased.

As a method for resolving this problem, the International patent publication No. WO03/068580 (PCT/SE03/00243) discloses a wheel construction in which the wheel construction is provided with a sliding member having a specific curved surface and being able to slide along a predetermined guide lane in stead of using the above-mentioned fan-shape type swing member which can be rotated around a predetermined rotational center, and when a portion of the sliding member contacted to a step portion or the like, the sliding member is caused to be moved in a direction opposite to the moving direction of the vehicle with keeping the situation in which the sliding member and the step portion are contacted with each other, in accordance with a continuous forward movement of the vehicle.

And it is also shown therein that with the same theory as described in the previous prior arts references, a wheel of the wheel construction is raised and at a time when the wheel thereof has landed on an upper surface of the step portion, the sliding member is returned to its original position.

The wheel construction having such kind of configuration, however, has a separate problem in that a lower surface portion of the sliding member is easily worn off every when it is contacted with the above-mentioned obstacles and thus it is required for the sliding member to be exchanged frequently.

A wear preventing member in addition thereto, it is also has a drawback in that since at every time when the sliding member is returned to its original position, a big noise is generated due to a collision of the sliding member with a front end portion of the wheel supporting portion in the wheel construction, the user using the vehicle always feels uncomfortable as well as the life time of the sliding member is shortened.

Further, in the past wheel construction, the vehicle body connecting portion which is connecting the wheel construction and the vehicle is configured so that the vehicle body connecting portion cannot smoothly be rotated and thus even when the wheel construction is used for a guiding wheel and provided at a front end portion of a predetermined vehicle in its moving direction, a front end portion of the wheel construction cannot be correctly directed to its moving direction, and accordingly in the most significant case, it is expected that there are many cases in which the front end portion of the wheel construction is directed to a different direction from the moving direction of the vehicle with a predetermined angle formed therebetween.

Accordingly, as the result thereof, it becomes impossible for the vehicle to climb over an obstacle when the wheel construction contacts with the obstacle such as a step portion or the like, as well as the wheel construction is frequently suffered from damages therefore.

In addition to the above-mentioned, regarding the vehicle provided with the above-mentioned wheel construction, when the wheel construction falls down from the upper surface of the step portion to the normal moving surface, in adverse, there also exists a problem in that a significant amount of shock is transmitted to the vehicle body portion and thus the user getting on the vehicle, usually receives uncomfortable shock as well as the goods mounted on the vehicle are displaced or fallen down.

Accordingly, in order to overcome the above-mentioned past drawbacks, an object of the present invention is to provide a wheel construction having a simple and an economical configuration as well as highly utilization value with compact configuration and having a characteristics in which it can easily climb over an obstacles including a step portion or a projected portion each having a predetermined height with the simple configuration and with a simple operation so that it can climb over such obstacles by a manual operation of the user thereof or with small amount of electric energy consumption when it is driven by a battery.

### SUMMARY OF THE INVENTION

Accordingly, in order to attain the above-mentioned object of the present invention, the wheel construction of the present invention basically has the technical configuration as shown hereunder.

Note that, the wheel construction of the present invention comprises a wheel supporting portion, a wheel axis provided on a part of the wheel supporting portion and to which at least one wheel is attached, a vehicle body portion of a vehicle on which the wheel is mounted, a vehicle body connecting portion provided on an upper part of the wheel supporting portion and connected to the vehicle body portion, a sliding member provided on a lower edge portion of the wheel supporting portion and facing to a moving surface along which the wheel moves, the sliding member further having a lower part contour with a configuration of a curved shape projecting against to the moving surface, and further wherein the sliding member being configured so that the sliding member is capable of moving in a direction perpendicular to the wheel axis via a position beneath the wheel axis so as to show a curved locus projecting against to the moving surface, and a resilient member which is provided on the wheel supporting portion and applying a bias force to the sliding member so that the sliding member is held at a position which is a front end portion of the wheel supporting portion in the moving direction thereof in a normal situation, and wherein the wheel construction further comprising a wear preventing member which can prevent an outer surface of the sliding member from being worn away and which being provided on at least a portion of an outer lower surface of the sliding member forming the curved contour and facing to the moving surface.

As the wheel construction of the present invention adopts the above-mentioned technical construction, when the wheel construction of the present invention serving as a step covering castor, is used for a vehicle, for one example, traveling along a moving surface with loading luggage or goods thereon or with at least one person getting thereon, the vehicle can easily and safely climb over even a step portion existing either in-door or out-door, and having a height of 2 to 3 cm or the like, such a stop portion is generally acknowledged that it is very difficult for a vehicle having current castors to climb over such a step portion as mentioned above.

Further, in the past, when a vehicle with carrying a person thereon goes through a step portion having a height of 2 to 3 cm or the like so as to climb over it, an assistant person for the person getting on the vehicle tries to climb over such step portion by making the vehicle inclined backwardly with an inclination by several times larger than an inclination usually formed on the vehicle when it goes over the same step portion.

At this moment, the person who is sitting on the vehicle usually feels big uneasy about such a sudden inclination of the vehicle.

On the other hand, with regard to a vehicle operated by an electric or fuel-cell battery, when it goes over such a step portion, there also exists a big danger in which the vehicle is too inclined backwardly so that the vehicle is overturned causing the passenger of the vehicle to hit his head with the earth.

However, the wheel construction of the present invention does not have such problems at all and it is designed that the wheel construction of the present invention can climb over a step portion having a height of 5 cm in maximum and it has no danger to be overturned as well.

Further, in a specific embodiment of the wheel construction of the present invention, for example, it is constructed that each one of the wheel construction has at least two parallel wheels as shown in FIG. 3 and thus a total width of the wheels shows, for example, 14.5 cm which is a double width comparing with that of single wheel consisting the current castor.

Accordingly, the wheel construction of the present invention has no problem in which a wheel of the vehicle is captured by a groove provided on a floor at an elevator door or in which the vehicle loses its moving direction due to the braille points bricks arranged on outdoor pedestrian passage, so that the wheel construction of the present invention performs sophisticated effects and functions which make it possible for the vehicle using the wheel construction of the present invention to move correctly and easily without loosing its moving direction.

### BRIEF EXPLANATION OF THE DRAWINGS

FIG. 1 shows a side view of a construction of one embodiment for a wheel construction in the past.

FIG. 2 shows a perspective view of a construction of one embodiment for a sliding member in the past.

FIG. 3 shows a back side view for explaining a relationship between the sliding member and the wheel supporting portion in the wheel construction in the past.

FIG. 4 shows a side view of a construction of one embodiment for a sliding member in the past.

FIG. 5 shows a back view and a side view of a construction of one embodiment of the wheel construction in the present invention.

FIG. 6 shows a perspective view and a back view of a construction of another embodiment of the wheel construction in the present invention.

FIG. 7 shows an illustration for explaining a construction of one embodiment of a vehicle body connecting portion used in the wheel construction of the present invention.

FIG. 8 shows an illustration for explaining a construction of another embodiment of a vehicle body connecting portion used in the wheel construction of the present invention.

FIG. 9 shows an illustration for explaining about a configuration of a connecting rod used in the wheel construction of the present invention.

FIG. 10 shows an illustration for explaining a function of the vehicle body connecting portion used for the wheel construction of the present invention.

FIG. 11 shows an illustration for explaining about a bearing portion as used in the vehicle body connecting portion in the present invention.

FIG. 12 way of operation for the vehicle body connecting portion in the present invention.

FIG. 13 shows examples of vehicles to which the present invention can be applied.

FIG. 14 shows an illustration for explaining about another construction of the vehicle body connecting portion used in the present invention.

FIG. 15 shows an illustration for explaining about a separate example of the sliding member of the present invention.

FIG. 16 shows another embodiment of the vehicle body connecting portion of the present invention.

### DETAILED EXPLANATION OF THE PRESENT INVENTION

A construction of one specific embodiment of the wheel construction and a vehicle provided with the wheel construction in the present invention will be precisely explained hereunder with reference to the attached drawings.

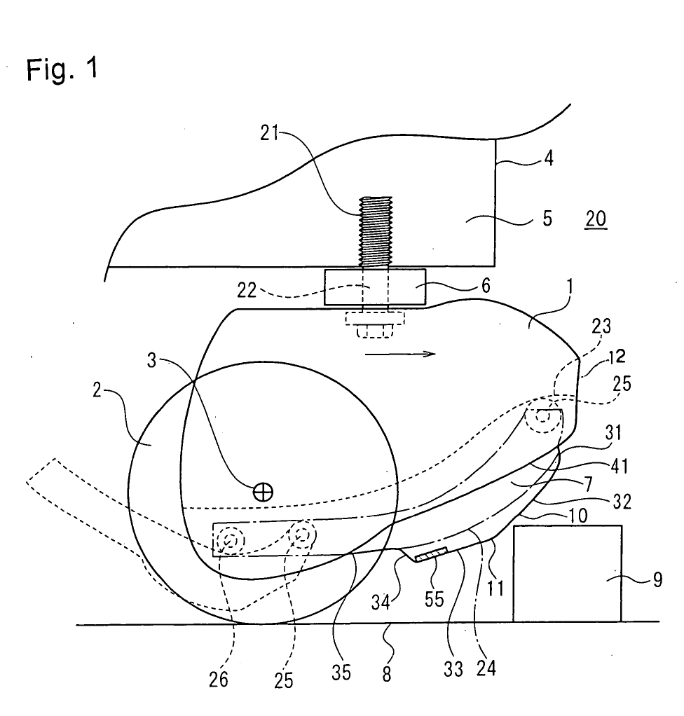

FIG. 1 shows a construction of one specific embodiment of a wheel construction of the present invention and in FIG. 1, a wheel construction 20 of the present invention is shown which comprises a wheel supporting portion 1, a wheel axis 3 provided on a part of the wheel supporting portion 1 and to which at least one wheel 2 is attached, a vehicle body portion 5 of a vehicle 4 on which wheels are mounted, a vehicle body connecting portion 6 provided on an upper part of the wheel supporting portion 1 and connected to the vehicle body portion 5, a sliding member 7 provided on a lower edge portion of the wheel supporting portion 1 and facing to a moving surface 8 along which the wheel 2 moves, the sliding member 7 further having a lower part contour 11 with a configuration of a curved shape projecting against to the moving surface 8, and further wherein the sliding member 7 being configured so that the sliding member 7 is capable of moving in a direction perpendicular to the wheel axis 3 via a position beneath the wheel axis 3 so as to show a curved locus projecting against to the moving surface 8, and a resilient member 13 which is provided on the wheel supporting portion 1 and applying a bias force to the sliding member 7 so that the sliding member 7 is held at a position which is a front end portion of the wheel supporting portion 1 in the moving direction thereof in a normal situation, and wherein the wheel construction 20 further comprising a wear preventing member 14 which can prevent an outer lower surface 10 of the sliding member 7 from being worn away and which being provided on at least a portion of an outer lower surface 10 of the sliding member 7 forming the curved contour and facing to the moving surface 8.

Note that regarding the vehicle used in the present invention, a kind of the vehicle is not specifically limited to a certain type of a specific vehicle but any one of the vehicles including a push-car, a wheel chair, a baby car, a vehicle used for a silver-aged person, a vehicle for carrying kids thereon or the like and which can use the wheel construction 20 of the present invention instead of using current front castor.

In the present invention, it is preferable that the wheel supporting portion 1 of the wheel construction 20 may be made of metallic material or hard plastics but the material thereof is not restricted specifically.

As shown in FIG. 1, the wheel supporting portion 1 of the wheel construction 20 of the present invention is provided with a vehicle body connecting portion 6 including therein a rod portion 22 having a pertinent thread screw coupling member 21 which can be connected to a specific vehicle body portion 5 of the vehicle 4.

In addition thereto, the wheel supporting portion 1 of the wheel construction 20 of the present invention is provided with an axis 3 to which a desired wheel 2 having a predetermined diameter is attached.

In the present invention, the number of the wheels 2 to be attached to the axis 3 is minimally 1 but preferably would be 2.

On the other hand, in the present invention, the wheel supporting portion 1 is further provided with a second guide roller 26 which can support a sliding movement of the sliding member 7 and comprising a pair of rollers.

The sliding movement thereof will be explained hereunder.

Note that, in the present invention, a sliding member 7 which can slideably move with relative to the wheel supporting portion 1 is provided on a lower portion of the wheel supporting portion 1 of the wheel construction 20 and at a lower edge portion 41 of the wheel supporting portion 1 which is opposite to a moving surface 8 along which the vehicle 4 moves.

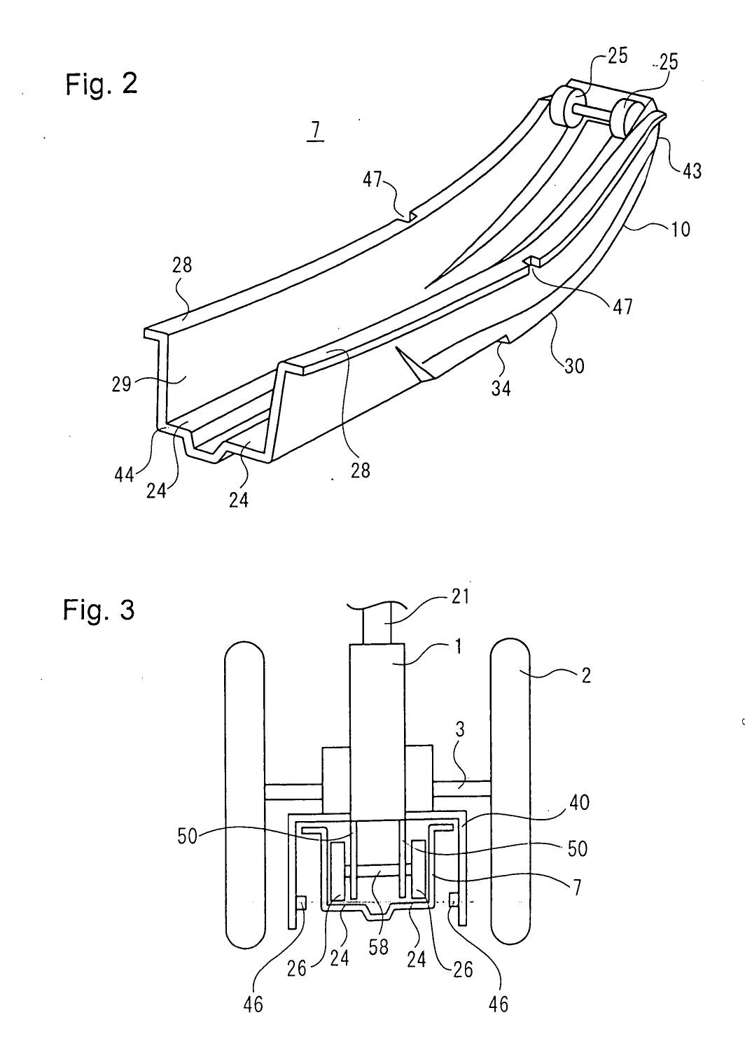

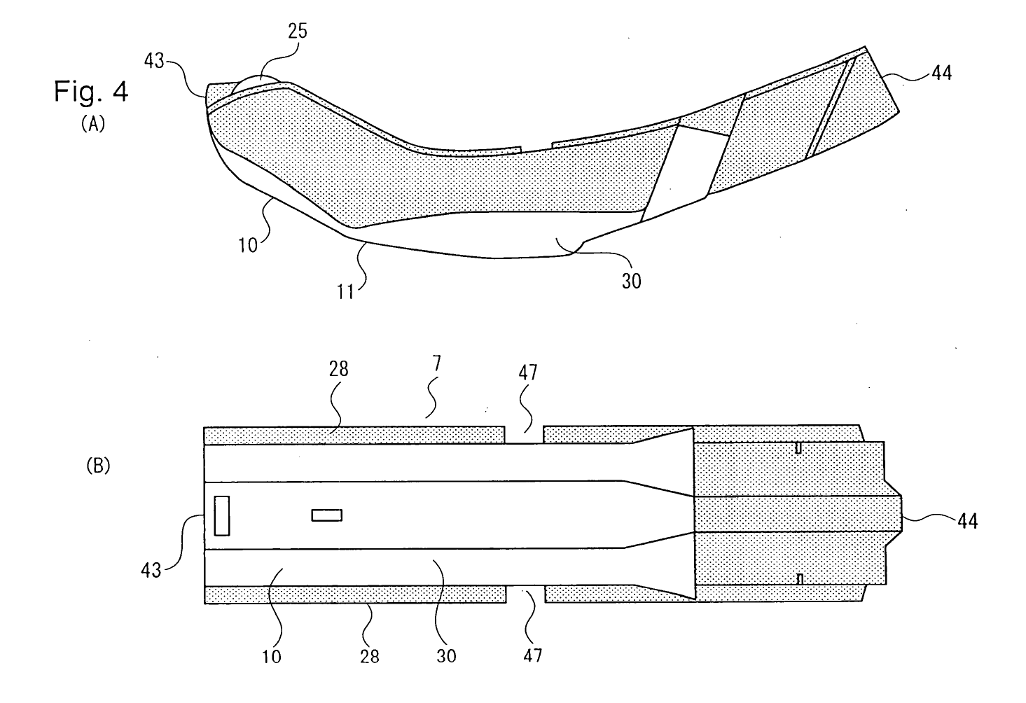

As shown in FIGS. 2 and 4, the sliding member 7 of the present invention comprises a main body portion 29 having an U shaped cross sectional configuration and a front end portion 43 thereof has a closed configuration with having a pair of first guide rollers 25 while at a rear end portion thereof being formed open-end configuration.

The first guide rollers 25 is configured so that they can move along a lane 23 showing a specific configuration and previously provided inside of the wheel supporting portion 1.

And further, a lower end surface 10 which is formed on an external bottom surface of the sliding member 7 and being opposite to a moving surface 8 along which the wheel 2 moves, has a lower portion contour 11 having a curved and convex configuration projecting to the moving surface 8 and further the sliding member 7 is configured so that it is capable of moving in a direction perpendicular to the wheel axis 3 of the wheel 2, via a position beneath the wheel axis 3 so as to show a curved locus projecting against to the moving surface 8.

Especially, it is preferable that the lower portion contour 11 which is formed on the lower end external surface 10 of the sliding member 7 and having the curved configuration projecting to the moving surface 8, has a configuration which can effectively raise the wheel axis 3 when the sliding member 7 meets an obstacle such as a step portion or a projection portion.

For example, as shown in FIG. 2, in a region 31 of the sliding member 7 and in the vicinity of the front end portion, the lower end external surface 10 should have a surface forming a wall like surface having approximately close to a right angle to the moving surface 8, and in the region 32 successive to the region 31, the lower end external surface 10 should also have a surface still forming a wall like surface having a relatively large angle to the moving surface 8, the angle thereof being reduced comparing with that in the region 31, though.

In a region 33 which is formed in successive to the region 32, the lower end external surface 10 should have a surface forming a wall like surface having a relatively small angle to the moving surface 8, the angle thereof being further reduced comparing with that in the region 32, though.

And further, in a region 35 which is formed in adjacent to the region 33 via a step like region 34, the lower end external surface 10 thereof forms a wall like surface which is approximately in parallel with the moving surface 8.

In the present invention, the configuration of the lower end external surface 10 is not restricted to the configuration as mentioned above and as shown in FIGS. 2 to 5 but it can be changed arbitrarily depending upon its necessity.

On the other hand, on a bottom portion 45 of the sliding member 7, a second guiding surface 24 to which a pair of guide rollers 26 which being fixedly provided on the wheel supporting portion 1 of the wheel construction 20 contact, is formed.

And the sliding member 7 is provided with a drop-off-prevention means 28 for preventing the sliding member 7 from being dropped off from the wheel supporting portion 1 and which is laterally extending from and along with both open ended top edge portions of the sliding member 7.

The drop-off-prevention means 28 is serving to prevent the sliding member 7 from dropping off from the wheel supporting portion 1 in cooperation with projecting portions 46 as provided inside surface of a cover portion 40 of the wheel supporting portion 1 as shown in FIG. 3.

Note that the drop-off-prevention means 28 is further provided with an aperture 47 through which the projecting portions 46 can pass, in suitable position thereof.

On the other hand, in order to make it sure that a surface 30 of the sliding member 7 of the present invention, which is opposite to the moving surface 8, can surely contact to an obstacle 9 including a suitable projecting portion or a suitable step like portion and the sliding member 7 can effectively and relatively slide in an opposite direction to a moving direction of the vehicle 4, it is preferable that the surface 30 should be made of a material having friction characteristic which is stronger than that of a material which forming the main body portion 29 of the sliding member 7 and having wear proof characteristic.

A connecting situation formed between the sliding member 7 and the wheel supporting portion 1 of the present invention is shown in FIG. 3.

Note that, a covering portion 40 having a wide width is formed at a lower end portion of the wheel supporting portion 1 and in an inner space formed inside of the covering portion, an wheel axis 58 is supported by a supporting plates 50 which are extended downwardly from the wheel supporting portion 1 of the wheel construction 20 and a suitable pair of guide rollers 26 are connected to both end portion of the wheel axis 58.

On the other hand, the open-end portion of the sliding member 7 of the present invention as shown in FIG. 2, is inserted into the covering portion 40 of the wheel supporting portion 1 so as to cover the guide rollers 26 with the sliding member 7 by aligning the aperture 47 formed on the drop-off-prevention means 28 with the projection portion 46 formed on an inside side wall of the covering portion 40.

By doing this, each one of the guide rollers 26 is arranged so that they can contact to each of the surfaces of the second guiding surfaces 24, respectively.

Further, as mentioned above when the sliding member 7 is inserted into the inside portion of the covering portion 40, as shown in FIG. 2, the projection portion 46 formed on an inside side wall of the covering portion 40 can pass through the aperture 47 formed on the drop-off-prevention means 28.

In the present invention, as shown in FIG. 4, it is further preferable that an external surface portion 30 of the sliding member 7 is made of a soft plastic material while the rest portion of the sliding member 7, such as a main body portion thereof is made of a hard plastic material.

And further it is preferable that the sliding member 7 may be made integrally by both of the soft plastic material for the external surface 30 thereof and the hard plastic material for the main body portion thereof using a simultaneous injection molding process or the like.

An optional portion of the sliding member 7 of the present invention is connected to one end of a resilient member 13, for example, a spring or the like, the another end of which being fixed to a portion of the wheel supporting portion 1 and thus the sliding member 7 of the present invention always receives a bias force so that it is always kept at in a direction to the front end portion of the wheel supporting portion 1 locating in the moving direction of the wheel supporting portion 1 mounted on the vehicle 4.

Accordingly, the wheel construction 20 of the present invention is so configured in that when the sliding member 7 contacts with an arbitrary obstacle 9, the sliding member 7 relatively slides backwardly which is in an opposite direction to the moving direction of the vehicle 4 opposing to the bias force applied thereto and after when the wheel 2 has succeeded to climb over the obstacle 9, the sliding member 7 can be returned to it original position.

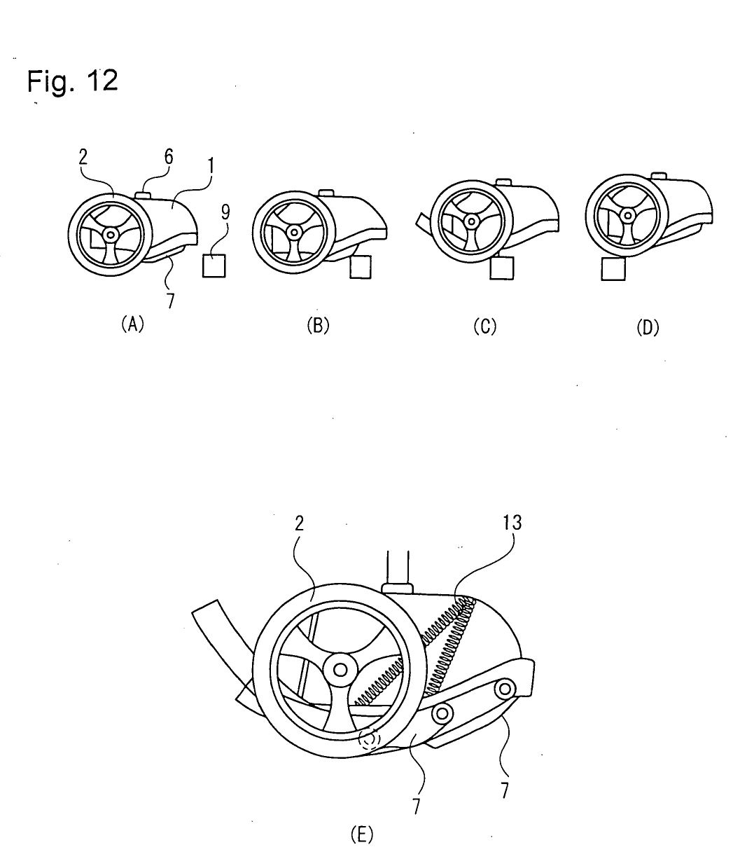

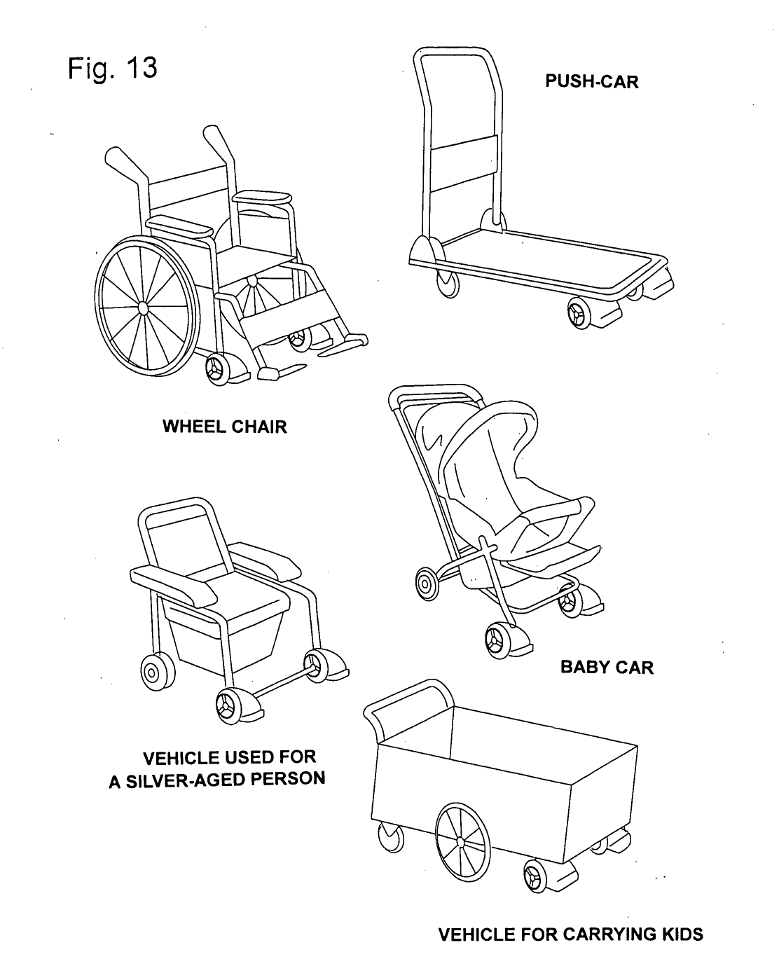

Hereunder, a principal of the present invention such as how the vehicle 4 using the wheel construction 20 of the present invention, can easily climb over such arbitrary obstacle vehicle 4, is explained with reference to FIG. 12.

Note that, as shown in FIG. 12(A), a wheel construction 20 of the present invention, which is used as front castors for a vehicle 4 such as a push-car or wheel chair or the like, approaches to an obstacle 9 and as shown in FIG. 12(B), when a front portion of the sliding member 7 of the wheel supporting portion 20 just contact with the obstacle 9, the sliding member 7 moves relatively in a backward direction to the wheel supporting portion 1 of the wheel supporting portion 20, since the vehicle 4 continues its movement in its moving direction for the vehicle.

Meanwhile, the sliding member 7 and the first guiding surface 23 formed inside the wheel supporting portion 1, and the second guiding member 24 and the external bottom surface of the sliding member 7 and which having a specific curved contour configuration cooperate with each other so as to effectively raise the wheel axis 3.

Next, in FIG. 12(C), the wheel 2 approaches to an upper surface of the obstacle 9 and as shown in FIG. 12(D), when the wheel 2 is completely mounted on the upper surface of the obstacle 9, since the sliding member 7 is released from the connection binding with the obstacle 9, the sliding member 7 can return back to the original position located in a front end portion of the wheel supporting portion 20 by the spring 13 or the like, so as to make another preparation for meeting the next obstacles.

Note that, FIG. 12(E) shows a construction of a separate embodiment of the wheel construction which can be used in the present invention.

Note that, the inventor of the present invention has acknowledged that several problems as shown hereunder are still existing on the mechanical construction for the above-mentioned wheel construction 20, after the inventor's careful investigation therefore.

That is, the sliding member 7 is currently produced by utilizing popular Nylon resin (for example, the Nylon plastic including at around 10% of glass component therein) and vinyl-chloride resin as the materials and is integrally molded with these two materials by two-layer simultaneous molding process and further, soft type vinyl-chloride resin can be preferably used so as to make the simultaneous molding process effective as well as to give the final product a cushioning characteristic.

However, the soft type vinyl-chloride resin has a drawback its self in which it is easily worn out.

From this point of view, the inventor of the present invention has engaged in a lots experimental test works in which the inventor has prepared the wheel construction 20 having the construction similar to that as explained above, and used it as castors of a pertinent vehicle and tried to climb this vehicle over an obstacle having a predetermined height for example 5 cm or the like. And the inventor has iterated to try this experiments many times and checked and monitored the wear out condition of the lower side edge portion 10 of the sliding member 7.

This experimental tests were carried out as follows;

Note that, the wheel construction 20 as shown in FIG. 1, was used as a castor of a pertinent vehicle 4 and the vehicle has been suffered from the experiments in which the following steps such as the vehicle climbs over an obstacle having a predetermined height as a first step and then it climbs down from the obstacle as a second step, and the above-mentioned one cycle test operation comprising the first and the second steps, had been iterated by 300 times in three days.

After this experimental test has been finished, the wearing condition of the lower outer surface of the sliding member 7 is detected.

As the results thereof, it was acknowledged that a portion of a region 33 of the lower external edge surface 10 of the sliding member 7 and which is continuously connected to a step like area 34 of the sliding member 7, as shown in FIG. 1, has been significantly worn off with a longitudinal length of about 1 cm.

The reason thereof is assumed that a somewhat abrasion force would affect between the upper surface of the obstacle 9 and the every when the sliding member 7 is returned back to its original position by the spring force just after the wheel 2 can climb over such obstacle 9.

Accordingly, when the wearing thereof would become too heavy, the specific surface area of the lower external edge surface 10 of the sliding member 7 would become too worn off causing the sliding member 7 would return back to its original position before the wheel 2 succeed to climb over the obstacle 9 and thus it would be difficult to obtain the wheel lifting effect.

Therefore, in order to overcome this problem, the inventor of the present invention, adopts the technical feature in which a wear preventing member 55 which can prevent an outer surface of the sliding member 7 from being worn away, is provided on at least a portion of an and which forming a curved contour 11 and facing to the moving surface 8, such as the most significantly worn out portion.

More specifically, it would be preferable that the portion which is most significantly worn out of the sliding member 7, is formed by a separate member made of a material having a relatively large abrasion characteristic which is larger than that of a material forming the main portion of the outer surface 10 of the lower external edge portion of the sliding member 7, or the portion should be covered by a plate like member made by a material having larger abrasion proofing characteristic.

Note that, the wear preventing member 55 as used in the present invention is preferably provided in the vicinity of the portion which can mostly approach to the moving surface 8 in the sliding member 7.

On the other hand, in another embodiment of this invention, it can also possible that at least one rotatable cylindrical member or a roller made by a metal or hard synthetic resin is provided at a portion at which the wear is the most significant.

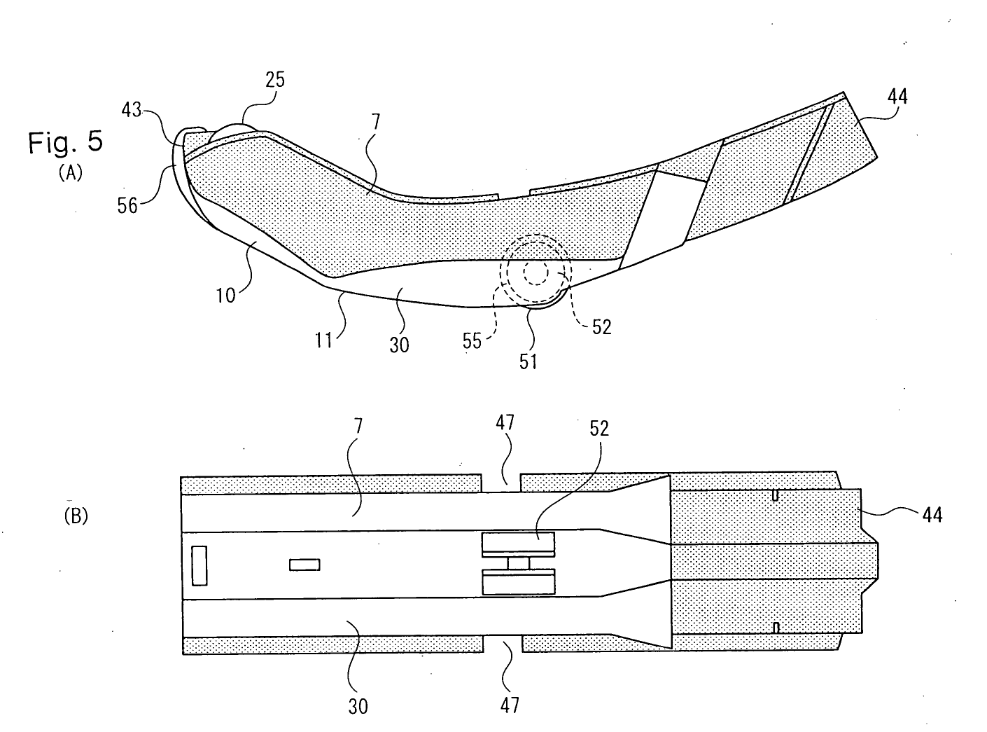

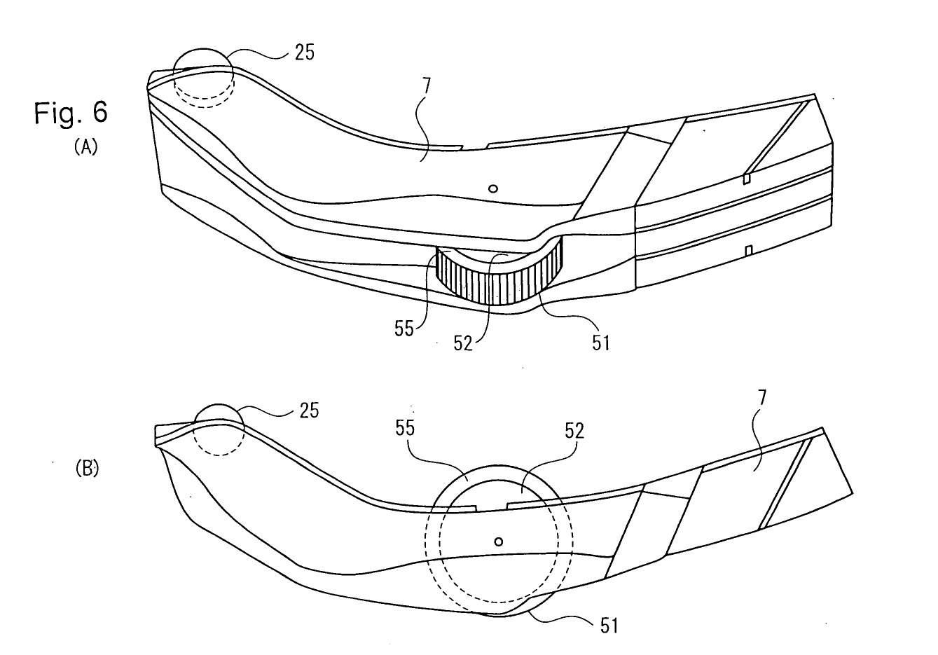

Specifically, as shown in FIGS. 5(A) and 5(B), on the portion of the outer lower surface 10 of the sliding member 7 and which is suffered from being worn out significantly, at least one predetermined aperture 51 is provided and it is preferable that a part of a roller or a pair of rollers 52 having a predetermined relatively small diameter is projected outwardly via the aperture 51.

Alternatively, it is also preferable that as shown in FIGS. 6(A) and 6(B), on the portion of the outer lower surface 10 of the sliding member 7 and which is suffered from being worn out significantly, at least one predetermined aperture 51 is provided and a part of a roller 52 having a predetermined relatively large diameter is projected outwardly via the aperture 51.

And when the sliding member 7 is returned to the original position, a front end portion of the sliding member 7 and a front end portion of the wheel supporting portion 1 in the wheel construction 20 are mutually impinged to each other causing to generate big noize and thus an user of the vehicle 4 always feels uncomfortable and a separate problem is also raised in that a life time of the sliding member 7 under which the sliding member 7 can be used, is caused to be shortened.

Note that in a current wheel construction 20, when the wheel 2 of the vehicle 4 just climbed over a top of an obstacle 9 such as a projected portion or a step like portion, an engagement formed between the lower end external surface 10 of the sliding member 7 and a top surface of the obstacle 9 is released thereby the sliding member 7 is returned back to its original position by a spring force or the like.

However, in this moment, it is frequently implemented that a front end portion 43 of the sliding member 7 is usually impinged on an inner surface of a front end portion 12 of the wheel supporting portion 1 so that a noize is generated accordingly and further the front end portion 43 of the sliding member 7 or the inside surface of the front end portion 12 of the wheel supporting portion 1 is frequently suffered from receiving damages thereon and accordingly, the sliding member 7 or the wheel supporting portion 1 should be necessarily and frequently exchanged with a fresh one.

In order to overcome these problems, in the present invention, the above-mentioned wheel construction 20 is provided with at least one shock absorbing member 56 at a longitudinal front end portion 43 of the sliding member 7 and which is opposite to the front end position of the wheel supporting portion 1 in the moving direction thereof.

A material of the shock absorbing member 56 as used in the present invention is not restricted to a specific material but it is possible that the shock absorbing member 56 can be made of a material having excellent cushion characteristic, durability and strength such as a synthetic resin including foaming resin, leather, felt, natural gum or the like or spring material.

Further in the present invention, when a simultaneous integrating molding system is utilized, the shock absorbing member 56 can be made of a soft type plastic, for example, a synthetic polymer resin such as polyvinyl chloride base soft plastic, which is forming a surface 30 of the sliding member 7 which is facing to the moving surface 8.

Further, it is also preferable that when the sliding member 7 is produced by utilizing the simultaneous integrating molding system with the soft type polyvinyl chloride resin for the surface 30 and with hard type synthetic resin for the main body portion 29 of the sliding member 7, the soft type polyvinyl chloride resin can be extended to an external end surface of the front end portion 43 of the sliding member 7.

On the other hand, in the present invention, it is common that when the vehicle 4 is moved forward, the wheel construction 20 serving as a castor is configured so that the height of an obstacle which the wheel construction 20 of the present invention can climb over, is set at 5 cm and thus it is also common that the height of the covering portion 40 is set at 6 cm.

And further, the above-mentioned condition for setting the height as a height with which the vehicle 4 can climb over, is not become a problem but when a user of the vehicle wishes to climb over an obstacle with measuring the height thereof with his eyes, it sometimes becomes unclear whether or not the height there of an obstacle has the height over which the vehicle can climb over the obstacle.

In this situation, assuming that the user of a vehicle has decided himself that the vehicle can climb over an obstacle with his measurement by his eyes, when he rushed to move to the obstacle 9 having a height of 6 cm, for example, the vehicle is abutted to the obstacle 9 so that the user felt a strong shock as simultaneous therewith there exist a possibility in which a durability of the sliding member 7 made of plastic will be reduced as well as a problem is raised in that the sliding member 7 receives damages therefrom.

Accordingly, in the present invention, as shown above, at a front end portion 43 of the sliding member 7 of the wheel construction 20 or at a front end portion 12 which is serving as a cover portion of the wheel supporting portion 1, a suitable shock absorbing member 56 having, for example, a cylindrical, semi-cylindrical, or semi-spherical configuration or any cubic-type configuration or a nissen hut like configuration, each being made of rubber resin or synthetic resin such as silicon resin or the like circular made of, for example, is provided.

Accordingly, as a basic technical feature of the present invention, the wheel construction 20 has a sliding member 7 which has an external surface 30 including a lower end surface 10 which is opposing to a moving surface 8 and being extended up to a front end portion 43 in the longitudinal direction of the sliding member 7 and the external surface 30 thereof is covered with a material having abrasion resistance characteristic and shock absorbing function.

Further, in the present invention, it is preferable that an angled end edge portion, an angled corner edge portion or any projecting portions of the sliding member 7 and of a lower edge portion 41 a cover member 40 of the wheel supporting portion 1, each being formed with an acute angel, is provided with a rounded configuration.

Note that, all of the edge portion of the sliding member 7 used in the wheel construction 20 and/or of the lower edge portion 41 of the cover portion 40 used in the wheel supporting portion 1 of the present invention are formed during a molding process when it is produced, so that all of such angled end edge portion, the angled corner edge portion or the any projecting portions formed thereon, are produced with a coarse condition so as to have a lots of splinters or notched portions remained thereon of.

Under this situation, when an operator tries to assemble the wheel construction 20 or when an user of the vehicle 4 uses the vehicle, it is possible for them to be frequently suffered from receiving damages on their hand or arm.

Further, under such situation, especially when such vehicle 4 contacts with an obstacle 9 such as a projecting portion or a step like portion as well as when the user of the vehicle tries to climb over such obstacle 9, due to his lack of experience about how to control this vehicle, the lower edge portion 41 of the cover portion 40 of the wheel supporting portion 1 is rubbed with the obstacle 9 with an abrasion so that the lower edge portions 41 on both side portion thereof is easily received damages which is relatively significant, unexpectedly, so that when the user tries to touch to or make an maintenance of these portions, this portion would give him harmful or ganger.

For the sake of this, in the present invention, it is preferable that as mentioned above, all necessary portions existing on the wheel construction of the present invention, are given rounded configurations, respectively (note that they should be treated with a rounding treatment.

Note that, in the past, the currently used castor is generally designed so that a wheel of the castor is naturally directed to a moving direction of a vehicle.

However, in the past wheel construction 20, there is a problem in that the wheels of the wheel construction 20 do not quickly face to a direction to which the vehicle is moved.

And it is considered that a main reason thereof is due to a fact that the wheel construction 20 is configured so that a vehicle body connecting portion 6 which is connecting the wheel construction 20 and a suitable vehicle 4, cannot be smoothly rotated.

Accordingly, even when the wheel construction 20 of the present invention is used for guide wheels by providing them on a front end portion of a desired vehicle 4 in a moving direction, the front end portion 12 of the wheel supporting portion 1 used in the wheel construction 20 cannot be quickly and accurately faced to a direction to which the vehicle wishes to move and further, in an extreme situation, since the front end portion 12 of the wheel supporting portion 1 is arranged so as to form with perpendicular to the direction to which the vehicle 4 moves or with a predetermined angel to the direction to which the vehicle 4 moves, there are many expected cases in which only a side surface of the wheel supporting portion 1 or only a side surface of the wheel is abutted to an obstacles 9.

Accordingly, when the wheel construction 20 contacts with the obstacle 9 such as a step-like configuration, it is quite impossible that the vehicle 4 can climb over the obstacle 9 and separate drawbacks would be increased in that the wheel construction 20 can be suffered from receiving damages thereon.

Even in the conventional castor, there still remains further problem in that when the vehicle 4 has changed its moving direction and after this time it moves along the selected direction quietly, the castors do not correctly direct to its moving direction.

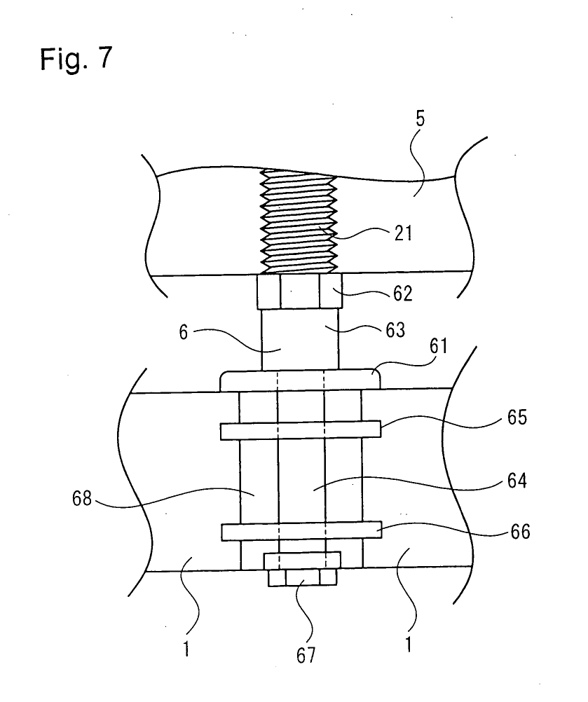

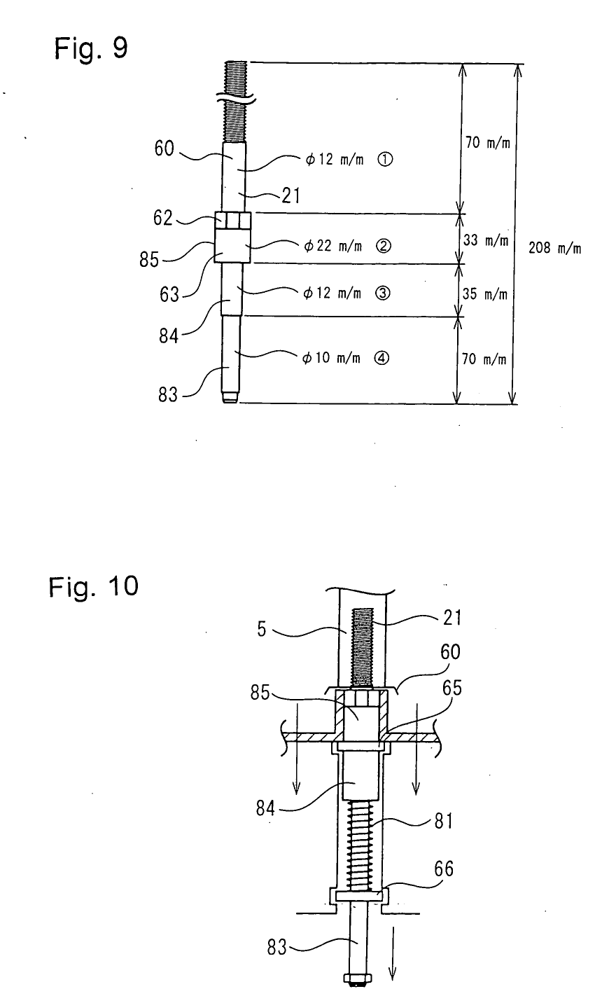

For the sale of this, in the present invention, as shown in FIGS. 7 and 9, a bearing mechanism 65 or 66 is provided on the vehicle body connecting portion.

By doing this, a rotation of a rod 22 comprising the vehicle body connecting portion 6 is made smooth by utilizing at least one bearing provided in side the wheel supporting portion 1 which can cause an operation for climbing over the obstacle 9 to be easy, just after the vehicle 4 has changed its moving direction.

For more specifically, the wheel supporting portion 1 is characterized in that a pair of bearing mechanism 65 and 66 are arranged at the vehicle body connecting portion 6.

Note that, as shown in FIG. 7, the vehicle body connecting portion 6 which is provided on an upper surface of the wheel supporting portion 1 in the wheel construction 20 and at a portion in proximity to a main body portion 5 of the vehicle 4, is provided with at least one aperture 68 inside a main body portion of the wheel supporting portion 1, to which an end portion 64 of a connecting rod member 60 can be inserted, the end portion 64 of which being an opposite end portion to another end portion of the connecting rod member 60 on which a thread screw mechanism 21 which can be met with a predetermined meeting portion being provided on the main body portion 5 of the vehicle 4.

In the aperture 68 at least one bearing member 65 is provided.

And the preferable embodiment of the present invention, as shown in FIG. 7, two bearing members are provided inside the aperture 68 in parallel and adjacently with each other with interposing a predetermined distance therebetween.

The rod member 60 used in the present invention is provided with a screw-in-operation portion 63 having a diameter being larger than that of the thread screw portion 21 in connection with the thread screw portion 21 and partly having a cut portion 62 to be captured by a wrench or the like.

Further, on the opposite end portion of the thread screw portion 21 which is adjacently arranged to the screw-in operation portion 63, there is provided an insertion end portion 64 which is supported by the bearing members and having a diameter being smaller than that of the screw-in operation portion 63.

In addition, a suitable securing member 67 which can be secured by the bearing member is provided at the most end part of the rod member 60.

Note that, in FIG. 7, 61 denotes a suitable cap member which is fixedly provided on the wheel supporting portion 1 and having a suitable aperture which allows the screw-in operation portion 63 and the insertion end portion 64 to get through.

Further note that, in the above-mentioned embodiment of the present invention, a pair of bearing members 65, 66 are provided inside of the vehicle body connecting portion 6 and the insertion end portion 64 of the connecting rod member 60 which being provided at one end portion thereof and being opposite end portion thereof on which a screw thread portion 21 which can be threaded into a main body portion 5 of a vehicle, is supported by the bearing members 65 and 66.

By adopting this kind of configuration, the wheel construction 20 which is connected to a vehicle 4 via the vehicle body connecting portion 6 can be easily and surely pivoted with respect to the vehicle 4.

In addition thereto, in the past wheel construction 20, after it has succeeded to climb over an obstacle 9 and then when it tries to get down from the obstacle or to descend down along a slope forming from a top of the obstacle 9, since no function for supporting the vehicle 4 to go down from the obstacle 9 is provided on the vehicle 4, the wheel 2 provided on the wheel supporting portion 1 of the wheel construction 20 directly fall down from the top of the obstacle or a projecting portion 9 to the moving surface 8, therefore, a significant shock is used to be applied to the vehicle 4.

Accordingly, in the past, with respect to a vehicle 4 as mentioned above, when it goes down from a top of the obstacle 9 to the moving surface, a problem is arisen in that a significant shock is transferred to the vehicle 4 so that the luggage on the vehicle are displaced or dropped off as well as the user getting on this vehicle 4 feels uncomfortable shock.

In order to overcome this problem, in the present invention, a spring member for absorbing such shock is provided in the vehicle body connecting portion 6 so as to minimally loosen such shock.

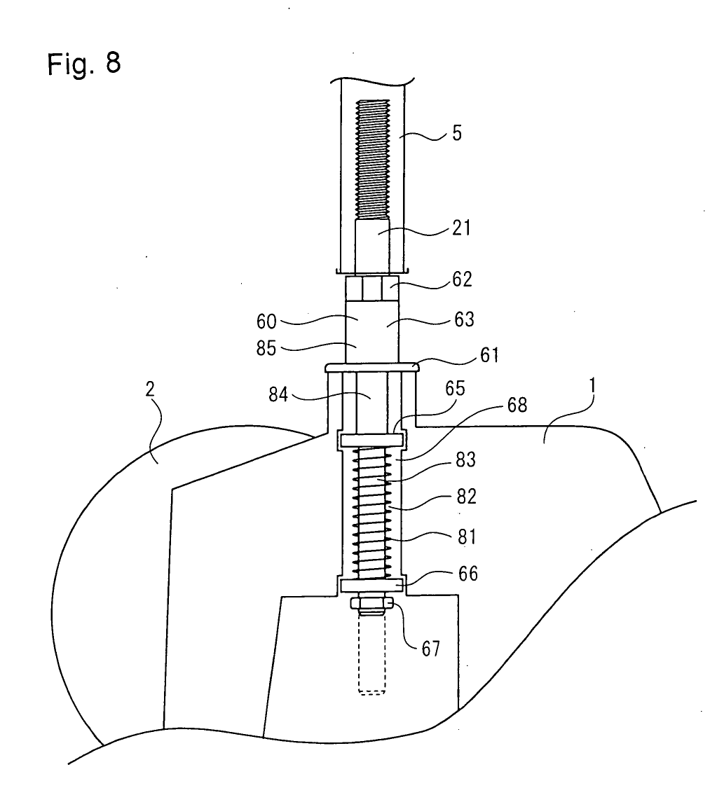

In the present invention, as shown in FIG. 8, a shock absorbing mechanism 81 is provided inside of the vehicle body connecting portion 6.

It is preferable that the shock absorbing mechanism 81 is provided in the bearing mechanism in which at least two bearing members are arranged to each other with a predetermined distance interposing therebetween.

As the shock absorbing mechanism 81 of the present invention, any kinds of shock absorbing mechanism can be used ,for example, the mechanism with a spring mechanism, with a compressed air mechanism, or with an oil pressure mechanism.

In the present invention, it is preferable that the shock absorbing mechanism 81 should be formed with the spring mechanism 82.

A preferable embodiment of the shock absorbing mechanism 81 of the present invention, will be explained hereunder with reference with FIGS. 8 to 11.

Note that, a basic mechanism of the shock absorbing mechanism 81 of the present invention has a configuration approximately similar to the bearing mechanism as shown in FIG. 7 but a different point thereof is such that it is configured so that a spring member 82 is provided between the bearing members 65 and 66.

In the shock absorbing mechanism 81 of the present invention comprises the vehicle body connecting portion 6 which is provided on an upper surface of the wheel supporting portion 1 in the wheel construction 20 and at a portion in proximity to a main body portion 5 of the vehicle 4.

The vehicle body connecting portion 6 is provided with at least one aperture 68 inside a main body portion 5 of the wheel supporting portion 1, to which an end portion 64 of a connecting rod member 60 can be inserted, the end portion 64 of which being an opposite end portion to another end portion of the connecting rod member 60 on which a thread screw mechanism 21 which can be met with a predetermined meeting portion being provided on the main body portion 5 of the vehicle 4.

As a preferred embodiment of the present invention, as shown in FIG. 8, two bearing members 65 and 66 are adjacently arranged in the suitable aperture 68 provided inside the wheel supporting portion 1, with interposing a predetermined distance therebetween

The rod member 60 as used in the present invention, has approximately a similar configuration of the rod member 60 as shown in FIG. 7.

Note that, the rod member 60 used in the present invention is provided with a screw-in-operation portion 63 having a diameter being larger than that of the thread screw portion 21 in connection with the thread screw portion 21 and partly having a cut portion 62 to be captured by a wrench or the like.

Further, following to the screw-in-operation portion 63, a connecting rod portion 84 is provided in succession therewith having a diameter being smaller than that of the screw-in-operation portion 63 but being identical to that of the thread screw portion 21.

And further, an insertion end portion 83 which is supported by the bearing members and being directly connected to the connecting rod portion 84 is provided.

Note that the diameter of the insertion end portion 83 is desirably designed to be smaller than any one of the diameters for all other members as mentioned above.

One specific embodiment about a diameter and a length of each one of the above-mentioned portions in the connecting rod 60 of the present invention are illustrated in FIG. 9.

Further, in this embodiment of the present invention, the lower end portion 83 can be also secured on the wheel supporting portion 1 with utilizing a suitable securing member 67.

Note that, in the present invention, it is preferable that the connecting rod 60 comprises a plurality of regions each having a respective diameter which is different from each other, except for the thread screw portion 21 which can meet with a suitable main body portion of the wheel supporting portion 1 with a thread coupling mechanism.

Further in the connecting rod member 60 of the present invention, a first region 83 is disposed at one end portion of the which is an opposite end portion thereof at which the thread screw portion 21 is provided and the first region 83 has the smallest diameter in the connecting rod member 60.

And the first region 83 is configured so that it has a diameter which can pass through an aperture 92 of a first bearing member 66 which is oppositely arranged to the sliding member 7 inside of the wheel supporting portion 1 and an aperture 91 of a second bearing member 65 which is oppositely arranged to the vehicle 4, simultaneously, while the second region 84 next to the first region 83 has a diameter which can pass through the aperture 91 of the second bearing member 65 and further, the third region 85 which is arranged between the second region 84 and the thread screw portion 21, has a diameter which is larger than that of the aperture 91 of the second bearing member 65 but smaller than that of an aperture 90 of a cap portion 61.

In the present invention, the configuration of the third region 85 is similar to that of the screw-in-operation portion 63 as shown in FIG. 7.

It is desirable that the third region 85 of the present invention can contact to the second bearing member 65, when a predetermined load is applied to the main body portion 5 of a vehicle 4.

And further, in the present invention, when a vehicle 4 is empty, the spring member 82 is in an extended condition and thus the third region 85 in the rod portion 6 is projected upwardly from the cap portion 61 and thereby this portion can be seen by human eyes.

But this portion can be concealed by providing a suitable cover portion so as for it not to be seen externally.

On the other hand, when the vehicle is loaded, for example, since the spring member 82 is contracted by about 3 cm or the like, the third region 85 in the rod portion 6 is covered with an external side surface of the wheel supporting portion 1 and thus it cannot be seen externally.

In such situation, the second region 84 of the rod portion 6 is descended downwardly through the aperture 91 of the second bearing member 65 with pushing down the spring member 82.

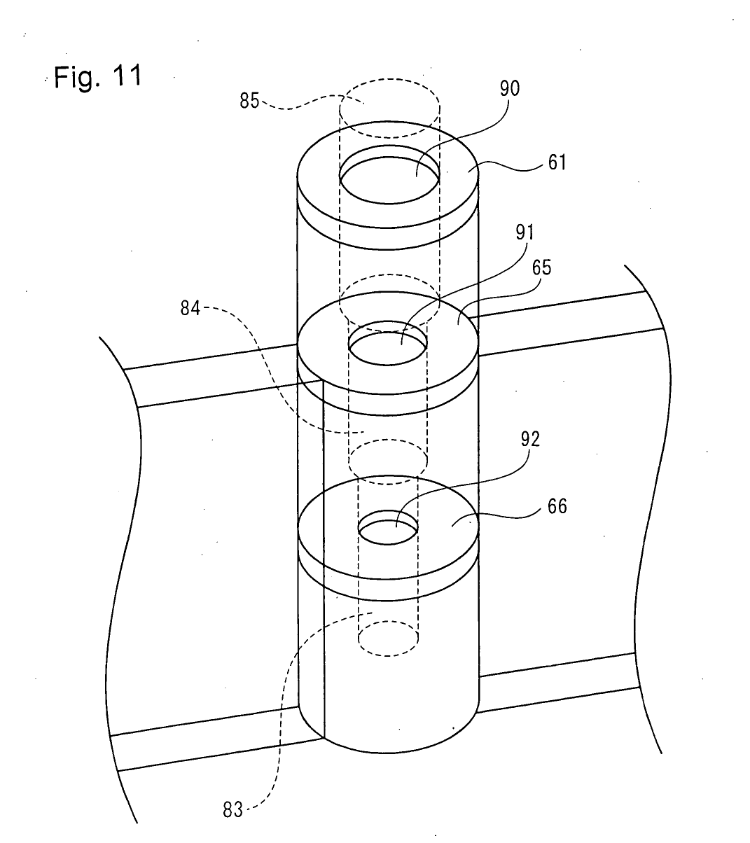

Accordingly, as the result, the down ward movement of the third region 85 of the rod portion 6 is stopped when it just contacts to a surface of the aperture 91 of the second bearing member 65 and this situation is illustrated in FIG. 10.

Note that, FIG. 11 shows relationships among the inside diameter of the aperture 90 of the cap portion 61, the inside diameter of the aperture 91 of the second bearing member 65 and the inside diameter of the aperture 92 of the first bearing member 66.

As shown in FIG. 11, the inside diameter of the aperture 92 of the first bearing 66 is set to be larger than the diameter of the first region 83 of the rod portion 6 and the inside diameter of the aperture 91 of the second bearing 65 is set to be larger than the diameter of the second region 84 of the rod portion 6 and to be smaller than that of the third region 85 of the rod portion 6.

Further, the inner diameter of the aperture 90 of the cap portion 61 is set to be larger than the diameter of the third region 85 of the rod portion 6.

The bearing member 65 and 66 of the present invention, a any suitable bearing mechanism is possibly used and thus it is also possible that the bearing member is configured so that a bearing member is inserted in the wheel supporting portion 1 with utilizing a well known method.

On the other hand, in the present invention, since the above-mentioned configuration is adopted, when a vehicle 4 goes down from an obstacle 9, the wheels 2 of the vehicle 4 is descended in such a way that the spring mechanism can be extended during the wheels 2 are still floating in the air, and accordingly, since a situation in that the spring member is pushed by a self-weight of the vehicle is created immediately and exactly in time when the wheel just lands on the moving surface 8 so that the shock caused by the landing can be softened.

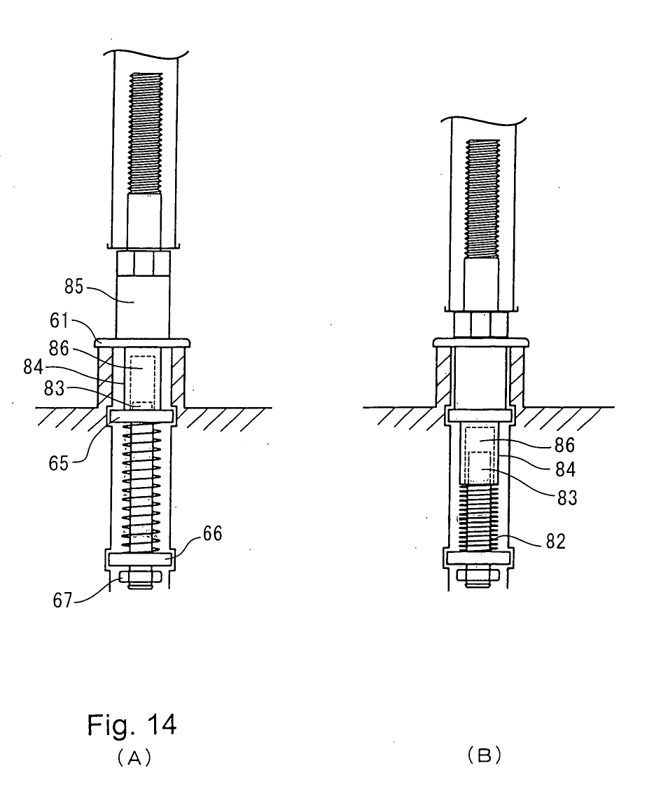

Next, another embodiment of the shock absorbing mechanism 81 of the present invention will be explained with reference to FIG. 14.

Note that the configuration of the shock absorbing mechanism 81 as shown in FIGS. 7 to 11 has a construction in that one connecting rod portion 60 which is solidly made and a spring member are used and therefore, the lower end portion of the connecting rod portion 60 is configured so that when the spring member is compressed, the lower end portion thereof is projected into the inside space formed inside of the wheel supporting portion 1.

Accordingly, it is necessary to design the inside space of the wheel supporting portion 1 so as to have a pertinent size, previously or in other case, a separate problem is arisen in that there exists a danger for the projected portion of the rod member 60 causes to give a user some damages.

Further, since the length of the connecting rod member 60 itself will be longer, operators feel inconvenience when the wheel construction 20 is assembled or when it is used.

In order to overcome this problem, as shown in FIG. 14(A) the second region 84 of the connecting rod portion 60 is formed by a hollow cylindrical member in which a inner space 86 is provided inside of the hollow cylindrical member and further the first region 83 is formed as an independent member from the connecting rod member 60.

And further, a diameter of the first region 83 is set to be smaller than the inner diameter of the inner space 86 which is formed inside of the second region 84 so that the first region 83 can be easily inserted slidably into the inner space 86 formed inside of the second region 84.

And further, it is also possibly configured so that a suitable spring member 82 is provided between the second region 84 and a top end portion of the first region 83.

In this embodiment, by fixing the top end portion of the first region 83 to a part of the wheel supporting portion 1 or a part of the bearing mechanism 66, as shown in FIG. 14(B), when a suitable pressuring force is applied to the connecting rod member 60, the second region 84 is descended downwardly against to a spring force with allowing the end portion of the first region 83 to enter into the inner space 86 and finally, the second region 83 is stopped at a position in which a repelling force of the spring member is balanced with a compressing force.

In this embodiment, in a case in that the top end portion of the first region 83 is fixed by a bearing member 66, for example, the top end portion of the first region 83 can be prevented from being projected downwardly from the bearing mechanism 66 or the wheel supporting portion 1 even when a suitable pressured force is applied to the connecting rod member 60.

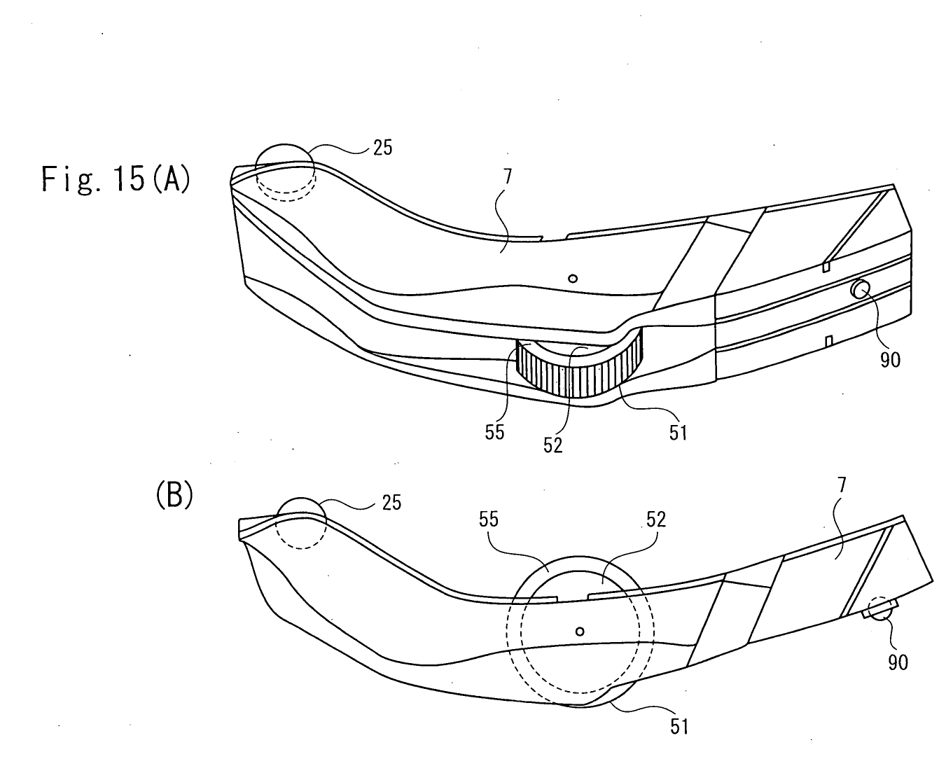

In a further separate embodiment of the present invention, as shown in FIG. 15, an attachment 90 having low abrasion characteristic may be provided at a rear end portion on the external lower end surface of the sliding member 7.

In the present invention, when an user of a vehicle 4 having the wheel 2 of the wheel construction 20 as a castor tries to climb over an obstacle 9, if his man power was too weak to succeed to climb over it, the wheel 2 fell down backwardly with remaining a part of the sliding member 7 on an edge of the obstacle 9 and thus the wheel 2 get into a condition in which the wheel 2 is impossible to be rotated so that the vehicle 4 cannot move any direction, since the contact formed between the a part of the sliding member 7 and the top edge of the obstacle and a contact formed between the rear end portion of the sliding member 7 and the moving surface 8 serve as brakes for the vehicle 4.

In order to overcome this problem, in the present invention, as shown in FIG. 15, an attachment 90 which serves as friction eliminating member so as to cancel the abrasion force generated in the contact formed between the rear end portion of the sliding member 7 and the moving surface 8 which serving as brakes for the vehicle 4.

The attachment 90 of the present invention is provided at any pertinent position on the external lower end surface of the sliding member 7 and between the most rear end portion thereof and the wear preventing member 51.

The attachment 90 in the present invention can be at least a rotatable roller, a rotatable spherical member,a wheel, a plate like member having a low abrasion characteristic or a movable endless belt.

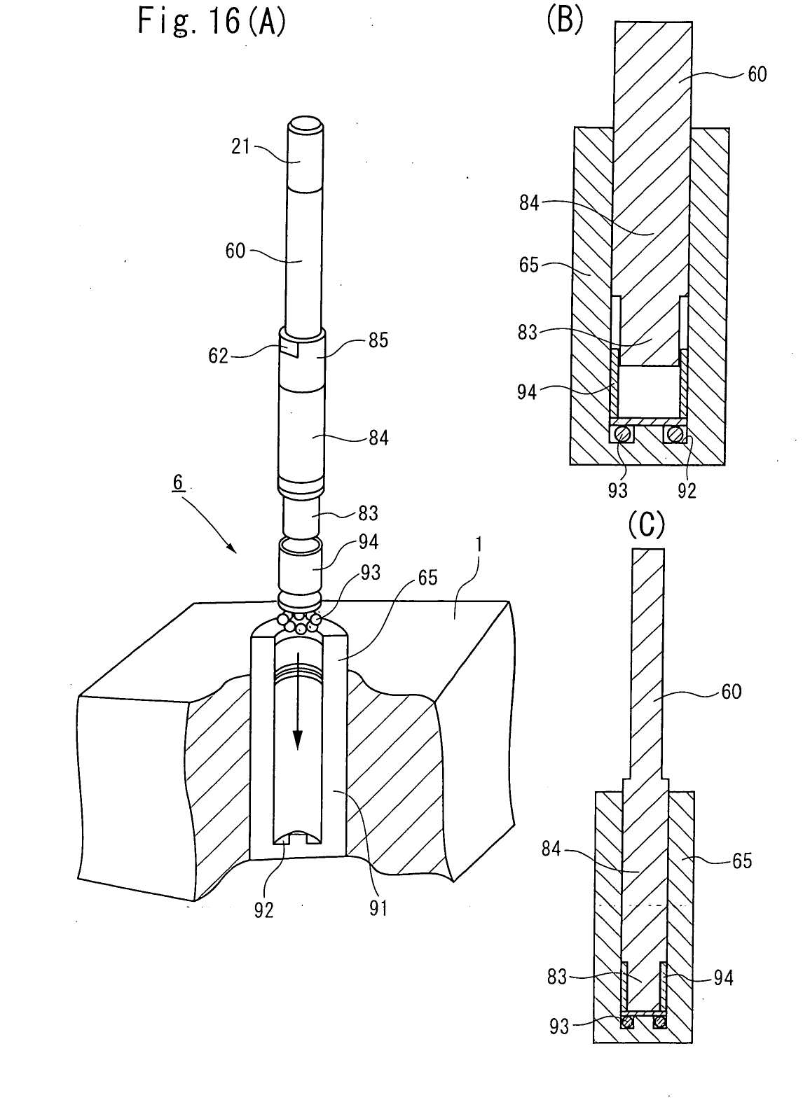

Hereunder, another embodiment of the vehicle body connecting portion 6 of the present invention will be explained with reference to FIG. 16.

Note that, in the present invention, a separate vehicle body connecting portion 6 as shown in

FIG. 16 which having a different configuration from the above-mentioned vehicle body connecting portion 6 as shown in FIGS. 8 to 11, can also be used in the present invention.

In this embodiment, the vehicle body connecting portion 6 comprises a bearing member 65 provided with a hollow cylindrical sleeve 91 with a bottom portion 92 and a roller bearing member 92 circularly arranged on the bottom portion 92, and in addition to the above-mentioned, a cylindrical hollow type spring member 94 is also provided inside of the cylindrical sleeve 91 so that a bottom portion of the cylindrical hollow type spring member 94 is directly contacted to the roller bearing member 92.

In this embodiment, the rod member 60 is also used for connecting the wheel supporting portion 1 and the vehicle body portion 5 and it has the similar configuration to that as shown in FIGS. 8 to 11.

Note that, the first region 83 of the rod member 60 has a diameter which being smaller than an inner diameter of the cylindrical spring member 94 so that the first region 83 can be easily inserted into the inner space of the cylindrical spring member 94.

FIG. 16(B) shows a condition in that the rod member 60 is not applied with a significant load and thus the cylindrical spring member 94 is in an extended condition so that the rod member 60 is raised over the bottom surface portion of the cylindrical spring member 94.

On the other hand, FIG. 16(C) shows a condition in that the rod member 60 is applied with a significant load and thus the cylindrical spring member 94 is in a contracted condition so that the rod member 60 is descended so that the lower end portion of the rod member 60 is contacted to the bottom surface portion of the cylindrical spring member 94.

The wheel construction 20 of the present invention can be used as a front wheel, such as a castor, for a vehicle including a push-car, a wheel chair, a baby car, a vehicle used for a silver-aged person, a vehicle for carrying kids thereon or the like and the present invention can provide a vehicle which can easily run along a moving surface which having a lots of step like portions or obstacles.

For example, in the present invention, a push-car having a castor which mounts the wheel construction 20 in replaced with the current front castor is obtained and this push-car can enable to eliminate the step portion problem safely without loosing any current superior functions for this car.

Further, in the present invention, by replacing the front castor of a wheel chair with the wheel construction 20 of the present invention, a sophisticated wheel chair with a castor which can go through a step like portion safely without loosing any current superior functions for the current wheel chair is obtained.

On the other hand, by replacing the front castor of a baby car with the wheel construction 20 of the present invention, a sophisticated baby car with a castor which can go through a step like portion safely without loosing any current superior functions for the current baby car is obtained and this baby car is especially useful when a plurality of babies get thereon, simultaneously.

As the same way, by replacing the front castor of a carrier for a silver aged person with the wheel construction 20 of the present invention, a sophisticated carrier for a silver aged person with a castor wheel chair which can go through a step like portion safely without loosing any current superior functions for the current silver aged person's carrier, is obtained.

1. A wheel construction in which said wheel construction comprising;
a wheel supporting portion;
a wheel axis provided on a part of said wheel supporting portion and to which at least one wheel is attached;
a vehicle body portion of a vehicle
a vehicle body connecting portion provided on an upper part of said wheel supporting portion and connecting to said vehicle body portion;
a sliding member provided on a lower edge portion of said wheel supporting portion and facing to a moving surface along which said wheel moves, said sliding member further having a lower part contour with a configuration of a curved shape projecting against to said moving surface, and further wherein said sliding member being configured so that said sliding member is capable of moving in a direction perpendicular to said wheel axis via a position beneath said wheel axis so as to show a curved locus projecting against to said moving surface; and
a resilient member which is provided on said wheel supporting portion and applying a bias force to said sliding member so that said sliding member is held at a position which is a front end portion of said wheel supporting portion in said moving direction thereof in a normal situation,
and wherein said wheel construction further comprising a wear preventing member which can prevent an outer surface of said sliding member from being worn away and which being provided on at least a portion of an outer surface of said sliding member forming said curved contour and facing to said moving surface.

2. A wheel construction according to claim 1, wherein said wear preventing member is formed with a plate like member made of either one of a metallic material or a plastic material.

3. A wheel construction according to claim 1, wherein said wear preventing member is formed with either one of a rotatable cylindrical member, a wheel like member and a roller member each being made of either one of a metallic material or a plastic material.

4. A wheel construction according to claim 1, wherein, said wear preventing member is provided on a vicinity of a portion of said moving surface which can most closely approach to said moving surface.

5. A wheel construction according to claim 1, wherein, said resilient member is configured so that one end portion thereof is held on a position which is a front end portion of said wheel supporting portion in a moving direction of said wheel supporting portion while another end portion thereof is held on a position located inside on said sliding member.

6. A wheel construction in which said wheel construction comprising;
a wheel supporting portion;
a wheel axis provided on a part of said wheel supporting portion and to which at least one wheel is attached;
a vehicle body portion of a vehicle;
a vehicle body connecting portion provided on an upper part of said wheel supporting portion and connecting to said vehicle body portion;
a sliding member provided on a lower edge portion of said wheel supporting portion and facing to a moving surface along which said wheel moves, said sliding member further having a lower part contour with a configuration of a curved shape projecting against to said moving surface, and further wherein said sliding member being configured so that said sliding member is capable of moving in a direction perpendicular to said wheel axis via a position beneath said wheel axis so as to show a curved locus projecting against to said moving surface; and
a resilient member which is provided on said wheel supporting portion and applying a bias force to said sliding member so that said sliding member is held at a position which is a front end portion of said wheel supporting portion in said moving direction thereof in a normal situation,
and wherein said wheel construction further comprising a shock absorbing member which is provided at least on a position at a front end portion of said sliding member in a longitudinal direction thereof and facing to said front end portion of said wheel supporting portion in said moving direction thereof.

7. A wheel construction according to claim 6, wherein, an external surface portion of said sliding member including an area comprising a portion existing from a lower surface portion thereof and facing to said moving surface to a front end portion thereof in a longitudinal direction, is covered with a material having either one of a wearing characteristic and a shock absorbing characteristic.

8. A wheel construction according to claim 1 or 6, wherein an end edge portion, a corner edge portion or a projecting portion of a lower edge portion of said sliding member or a cover member of said wheel supporting portion, is provided with a rounded configuration.

9. A wheel construction in which said wheel construction comprising;
a wheel supporting portion;
a wheel axis provided on a part of said wheel supporting portion and to which at least one wheel is attached;
a vehicle body portion of a vehicle;
a vehicle body connecting portion provided on an upper part of said wheel supporting portion and connecting to said vehicle body portion;
a sliding member provided on a lower edge portion of said wheel supporting portion and facing to a moving surface along which said wheel moves, said sliding member further having a lower part contour with a configuration of a curved shape projecting against to said moving surface, and further wherein said sliding member being configured so that said sliding member is capable of moving in a direction perpendicular to said wheel axis via a position beneath said wheel axis so as to show a curved locus projecting against to said moving surface; and
a resilient member which is provided on said wheel supporting portion and applying a bias force to said sliding member so that said sliding member is held at a position which is a front end portion of said wheel supporting portion in said moving direction thereof in a normal situation,
and wherein said wheel construction further comprising a bearing mechanism which is provided on said vehicle body connecting portion.

10. A wheel construction in which said wheel construction comprising;
a wheel supporting portion;
a wheel axis provided on a part of said wheel supporting portion and to which at least one wheel is attached;
a vehicle body portion of a vehicle;
a vehicle body connecting portion provided on an upper part of said wheel supporting portion and connecting to said vehicle body portion;
a sliding member provided on a lower edge portion of said wheel supporting portion and facing to a moving surface along which said wheel moves, said sliding member further having a lower part contour with a configuration of a curved shape projecting against to said moving surface, and further wherein said sliding member being configured so that said sliding member is capable of moving in a direction perpendicular to said wheel axis via a position beneath said wheel axis so as to show a curved locus projecting against to said moving surface; and
a resilient member which is provided on said wheel supporting portion and applying a bias force to said sliding member so that said sliding member is held at a position which is a front end portion of said wheel supporting portion in said moving direction thereof in a normal situation,
and wherein said wheel construction further comprising a shock absorbing mechanism which is provided on said vehicle body portion.

11. A wheel construction according to claim 9 or 10, wherein said bearing mechanism of said vehicle body connecting portion is provided inside said vehicle body portion and further said bearing mechanism supporting one end portion of a connecting rod member, another end portion thereof being provided with a thread screw portion which can meet with an opposite thread screw portion provided on a suitable portion of said vehicle body portion.

12. A wheel construction according to claim 9 or 10, wherein said bearing mechanism comprising at least two bearing portions, each being oppositely arranged to each other with providing a predetermined distance interposed therebetween and further provided with a shock absorbing mechanism arranged on between said pair of bearing portions.

13. A wheel construction according to claim 12, wherein said shock absorbing mechanism comprising a spring member.

14. A wheel construction according to claim 11, wherein said connecting rod member having a specific area portion, except for said thread screw portion which can be coupled with a suitable portion of said vehicle body portion, and said specific area portion comprising a plurality of areas each having a respective diameter which is different from each other.

15. A wheel construction according to claim 14, wherein said plurality of areas of said connecting rod member comprising
a first area which is formed at one end portion of said connecting rod member opposite to said another end thereof at which said thread screw portion is provided, having a diameter being the smallest one among those of said plurality of areas thereof, and said diameter being configured so that said first area thereof can get through both hole portions of a first bearing portion which is provided inside of said wheel supporting portion and opposite to said sliding member and of a second bearing portion provided opposite to said vehicle body portion,
a second area which is adjacently arranged to said first area and a diameter of said second area is configured so that said second area thereof can only get through said hole of said second bearing portion, and
a third area which is provided in between said second area and said thread screw portion of said connecting rod member and a diameter thereof being larger than that of said hole of said second bearing portion.

16. A wheel construction according to claim 15, wherein said third area is configured so that said third area can be contacted to said second bearing portion when a predetermined load is applied to said vehicle body portion.

17. A wheel construction in which said wheel construction comprising;
a wheel supporting portion;
a wheel axis provided on a part of said wheel supporting portion and to which at least one wheel is attached;
a vehicle body portion of a vehicle;
a vehicle body connecting portion provided on an upper part of said wheel supporting portion and connecting to said vehicle body portion;
a sliding member provided on a lower edge portion of said wheel supporting portion and facing to a moving surface along which said wheel moves, said sliding member further having a lower part contour with a configuration of a curved shape projecting against to said moving surface, and further wherein said sliding member being configured so that said sliding member is capable of moving in a direction perpendicular to said wheel axis via a position beneath said wheel axis so as to show a curved locus projecting against to said moving surface; and
a resilient member which is provided on said wheel supporting portion and applying a bias force to said sliding member so that said sliding member is held at a position which is a front end portion of said wheel supporting portion in said moving direction thereof in a normal situation,
and wherein said wheel construction further comprising at least one supplemental low frictional member which is provided on a rear portion of a lower and outer surface of said sliding member.

18. (canceled)
